(19) United States
(12) Patent Application Publication
(10) Pub. No.: US 2025/0163592 A1
(43) Pub. Date: May 22, 2025

(54) WIND-POWERED ELECTROLYSIS ARRANGEMENT

(71) Applicant: Siemens Gamesa Renewable Energy A/S, Brande (DK)

(72) Inventors: Jan Rudolf Eggers, Bliedersdorf (DE); Henrik Christian Lund Hellstern, Aarhus V (DK); Michael von der Heyde, Ahrensburg (DE)

(21) Appl. No.: 18/939,606

(22) Filed: Nov. 7, 2024

(30) Foreign Application Priority Data
Nov. 16, 2023 (EP) 23210233.5

(51) Int. Cl. C25B 9/65; C25B 1/04; C25B 9/19; C25B 9/70; C25B 15/08; F03D 9/00

(52) U.S. Cl. CPC C25B 9/65; C25B 1/04; C25B 9/19; C25B 9/70; C25B 15/085; C25B 15/087; F03D 9/00; F05B 2220/61

(57) ABSTRACT

A wind-powered electrolysis arrangement is provided including a plurality of wind turbines of an offshore wind park; a distributed electrolyzer plant including a plurality of electrolyzers, wherein each electrolyzer is arranged on a wind turbine platform; a balance of plant of the distributed electrolyzer plant, installed on a main platform in the wind park; and a plurality of product pipelines, wherein each product pipeline is arranged to convey a number of products between the balance of plant and a distributed electrolyzer. A method of operating such a wind-powered electrolysis arrangement is also provided.

### CROSS-REFERENCE TO RELATED APPLICATIONS

This application claims priority to EP Application Serial No. 23210233.5, having a filing date of Nov. 16, 2023, the entire contents of which are hereby incorporated by reference.

### BACKGROUND

A water electrolysis plant can be used to generate hydrogen gas (H₂) from a water supply such as seawater. The hydrogen produced by a large-scale water electrolysis plant can be used for various purposes, for example as fuel for vehicles, to manufacture ammonia, etc. A water electrolysis plant can comprise a stack of electrolyzer cells, for example PEM (proton-exchange membrane) electrolyzer cells, alkaline water electrolyzer cells, etc. In addition, the water electrolysis plant requires various other components, collectively referred to as the “balance of plant”. A PEM electrolyzer plant requires a purified water supply system for desalination of seawater as well as various other systems such as a nitrogen supply, an instrument air supply, a compressor, etc. An alkaline electrolyzer requires an alkaline solution of water and suitable electrolytes such as potassium hydroxide (KOH), sodium hydroxide (NaOH), etc.

Offshore wind farms (also called wind parks) are being used to provide power for large-scale water electrolysis plants. For example, power cables from an offshore wind farm can transport electricity to a large-scale electrolysis plant on the mainland. A disadvantage of this approach is the high cost of bringing the electricity to the electrolysis plant. Another disadvantage is the considerable power losses in the export power cables, further reducing the overall efficiency.

Alternatively, a large-scale electrolysis plant (the electrolyzer cells and the balance of plant) can be installed on a suitably large offshore platform, within or close to the wind farm. In such a scenario, power from the wind turbines can be transported to a centrally located transformer at the electrolyzer platform, for example. The export hydrogen can be transported to the mainland through a pipeline. A problem with this approach is the high cost of constructing such a large offshore platform. In this case also, power losses are incurred in transporting electrical power from the wind turbines distributed throughout the wind farm.

In another approach, electrolysis can be distributed over the wind turbines of the wind farm by connecting each wind turbine to its own “small-scale” electrolysis plant. In such a system, an electrolyzer and its balance of plant is installed directly at a wind turbine, for example on a platform at the base of the wind turbine tower. In this type of configuration, each electrolyzer must be equipped with a desalination unit, a backup power supply, an instrument air supply, a nitrogen supply, a hydrogen compressor, etc. In addition to the costs of providing a large number of such scaled-down electrolysis plants (for example one electrolysis plant for each of many wind turbines of the wind farm), a disadvantage of this distributed approach is that the number of components requiring service and repair is increased, since technicians will be required to visit each wind turbine of the wind farm in order to perform maintenance on each electrolyzer's balance of plant. Furthermore, it is necessary to collect the export hydrogen from each wind turbine installation for pipeline transport to the mainland, and this may require multiple compressor stages to be installed throughout the wind park.

### SUMMARY

An aspect relates to an offshore wind-powered electrolysis plant that overcomes the problems outlined above.

This aspect is achieved by the claimed wind-powered electrolysis arrangement and by the claimed method of operating such a wind-powered electrolysis arrangement.

Since large wind parks have been primarily located offshore, in the following it may be assumed that the inventive wind-powered electrolysis arrangement is realized in an offshore wind park. However, it shall be understood that the inventive wind-powered electrolysis arrangement can equally be deployed using an onshore wind park.

The supporting structure of an offshore wind turbine can be a monopile, a tripod, a jacket structure etc., carried by a foundation that is fixed to the seabed. Equally, the supporting structure of an offshore wind turbine can be a floating foundation. Generally, to facilitate access to an offshore wind turbine, the supporting structure also carries a platform, mounted for example on a transition piece between the support structure and the wind turbine, as will be familiar to the skilled person.

According to embodiments of the invention, the wind-powered electrolysis arrangement comprises a plurality of wind turbines of an offshore wind park, and a distributed electrolyzer plant comprising a plurality of electrolyzers. Each electrolyzer is attached in some way to the supporting structure of its wind turbine, for example an electrolyzer can be mounted on the type of platform described above. An arrangement comprising an electrolyzer and a wind turbine, as well as any structure(s) required to support the wind turbine and the electrolyzer, is referred to in the following as a “decentralized offshore hydrogen plant”, “decentralized onshore hydrogen plant”, or simply “DOHP”. As indicated above, there are various types of water electrolyzers. Since PEM water electrolyzers and alkaline water electrolyzers are particularly suited for wind-powered electrolysis plants, these may be mentioned in the context of exemplary configurations in the following. However, it shall be understood that embodiments of the invention are equally applicable to other types of water electrolysis.

The balance of plant of the distributed electrolyzer plant is installed on a main platform arrangement of the wind park. The main platform arrangement can comprise one or more large platforms, arranged centrally in the wind farm. The inventive wind-powered electrolysis arrangement further comprises a plurality of product exchange pipelines arranged to convey products between the balance of plant, the electrolyzers and their respective wind turbines.

A distributed electrolyzer plant can comprise as many electrolyzers as there are wind turbines in the wind farm. Equally, two or more distributed electrolyzer plants can avail of the wind turbines of a wind farm. Of course, not all wind turbines of a wind farm need to be dedicated to the distributed electrolyzer plant(s).

A wind park can comprise any number of wind turbines, for example several tens of wind turbines. These are generally arranged at regular intervals. It follows that the inventive wind-powered electrolysis arrangement can comprise the same number of DOHPs. Equally, the inventive wind-powered electrolysis arrangement can comprise a plurality of decentralized offshore hydrogen plants as well as a number of wind turbines that are used to generate electricity for export to a utility grid.

An advantage of the inventive configuration is that each electrolyzer is placed as close as possible to its source of power (the respective wind turbine), so that fewer transformation steps are required, leading to significantly reduced power losses, reduced system complexity and reduced capital expenditure (CAPEX). In the inventive wind-powered electrolysis arrangement, therefore, the efficiency of hydrogen production is increased. Equally, provision of the products necessary for water electrolysis (e.g., purified water, nitrogen, etc. for a PEM water electrolyzer or an aqueous alkaline solution for an alkaline water electrolyzer, etc.) is “outsourced” to a common balance of plant, installed on the main platform, which carries all units and modules necessary for the provision of these products.

According to embodiments of the invention, the method of operating a wind-powered electrolysis arrangement comprises the steps of providing a wind park comprising a plurality of wind turbines; arranging each of a plurality of electrolyzers of a distributed electrolyzer plant on a respective wind turbine platform; connecting the output power of each wind turbine to its electrolyzer; installing the balance of plant of the distributed electrolyzer plant on a main platform of the wind park; and exchanging products between the balance of plant and each of the distributed electrolyzers.

The balance of plant for the distributed electrolyzers—i.e., various installations necessary for running the distributed electrolyzers—is placed on the (permanently or intermittently manned) main platform arrangement, which is located centrally in the wind park, or at any location that permits an optimal arrangement of product exchange pipelines, i.e., an arrangement in which pipeline lengths are favourably short. The main platform arrangement can also carry various installations necessary for controlling the wind turbines. The main platform arrangement can comprise a single platform large enough to carry the balance of plant for the DOHPs. Equally, the main platform arrangement can comprise two or more platforms, which can be located in proximity to each other, or which can be distributed throughout the wind farm, as appropriate.

The offshore wind park can be located at a significant distance from the mainland. For example, if its wind turbines are carried by floating foundations, a wind farm can be located several hundred kilometres offshore. An advantage of the inventive configuration is that only an export hydrogen pipeline is required to transport the hydrogen to an onshore facility. The electricity generated by the wind park is consumed by the electrolyzer plant, and all products required for electrolysis are generated locally at the balance of plant.

Each product exchange pipeline conveys various products between the balance of plant and a DOHP. Since such a pipeline connects a DOHP with the centrally located balance of plant, it may be referred to herein as an “umbilical pipeline” or simply “umbilical”. An umbilical can be a conventional marine pipeline, made of a material such as HDPE, and is armored to avoid damage. Depending on the wind park location, water depth, water currents etc., an umbilical may be laid on the seabed and/or may be partially buried under the seabed. Equally, an umbilical may to some extent be allowed to float.

As indicated above, the wind-powered electrolysis plant can deploy PEM water electrolyzers. Since PEM water electrolysis requires pure water, each umbilical encloses a purified water pipe which conveys purified water from the balance of plant to the respective electrolyzer. Each umbilical further encloses a hydrogen pipe for conveying gaseous hydrogen from the respective electrolyzer to the balance of plant. In the inventive electrolyzer system, the purified water is conveyed from the balance of plant to each electrolyzer, and the hydrogen from that electrolyzer is conveyed in the opposite direction, back towards the balance of plant. Therefore, each umbilical encloses a fluid pipeline for conveying purified water in the direction of an electrolyzers, and another fluid pipeline for conveying hydrogen in the direction of the balance of plant.

An umbilical can enclose any number of further pipes, each carrying a specific product, for example: a nitrogen pipe for conveying nitrogen gas from the balance of plant to the respective electrolyzer, an instrument air pipe for conveying instrument air from the balance of plant to the respective electrolyzer.

Since the electrolyzers require pure water, the balance of plant comprises a water purifier system built at a scale sufficient to provide purified water to all DOHPs. Purification can commence with a desalination stage to remove salt ions from the seawater and can comprise various other stages to remove contaminants from the water. To ensure efficient electrolysis and to avoid damage to an electrolyzer, it is usual to perform electrodialysis or ion exchange in order to obtain ultra-pure water. However, ultra-pure water is difficult to store for any length of time, since ions or molecules from the inner surfaces of any enclosing vessel or pipeline, or from gases in contact with the water surface, transfer readily into the purified water. Such impurities can detract from the efficiency of the electrolyzer and can also result in damage. Therefore, in an embodiment of the invention, each DOHP is equipped with a water polishing unit for its electrolyzer. Performing this final “polishing” step at the DOHP ensures that the ultra-pure water cannot deteriorate, while avoiding the high costs associated with storage of ultra-pure water.

The balance of plant further comprises a nitrogen supply in order to supply gaseous nitrogen to the DOHPs, since a DOHP may need to purge its hydrogen system at some stage. For example, this can be necessary when the DOHP becomes operational for the first time, or after any electrolyzer downtime. The nitrogen supply can be an air separator, for example, or any suitable type of supply.

The balance of plant can further comprise an instrument air supply, for example an installation for generating compressed air that is conveyed in the umbilicals to the DOHPs. A DOHP can, for example, require compressed air to operate pneumatic valves in a fluid circuit of the electrolyzer. Compressed air can also be needed by other equipment of a DOHP, for example pressurized air can be fed into an electrical cabinet to avoid an undesirable accumulation of gaseous hydrogen (and development of an explosive atmosphere) inside the cabinet.

Each DOHP produces H₂ gas which is conveyed to the main platform via a hydrogen pipeline in the respective umbilical(s). The balance of plant can be configured to collect the hydrogen delivered by the DOHPs and to perform any compression required. A platform of the electrolysis arrangement can be equipped with a hydrogen offtake interface from which the compressed hydrogen can be exported.

In an alternative configuration, the wind-powered electrolysis plant can deploy alkaline water electrolyzers. In this case, each umbilical encloses a pipe which conveys an alkaline electrolyte solution (e.g., purified water and KOH; purified water and NaOH, etc.) from the balance of plant to the respective electrolyzer. Each umbilical further encloses a pipe for conveying the alkaline electrolyte solution, now also containing H₂ gas, from the respective electrolyzer to the balance of plant. Again, these pipes convey their fluid contents in opposite directions.

In this case also, an umbilical can enclose any number of further pipes, each carrying a specific product, for example: a nitrogen pipe for conveying nitrogen gas from the balance of plant to the respective electrolyzer, an instrument air pipe for conveying instrument air from the balance of plant to the respective electrolyzer.

Since the alkaline electrolyte solution should be prepared from pure water, the balance of plant in this case also comprises a water purifier system and an electrolyte preparation system which adds suitable quantities of the chosen electrolyte(s) to the purified water.

Each DOHP produces H₂ gas which remains in the liquid electrolyte and is returned to the balance of plant. This comprises a suitably-scaled separator for extracting the hydrogen from the liquid electrolyte. Further processing units may comprise a scrubber, a deoxygenator for removing molecular oxygen (O₂) from the return electrolyte, a drier for removing moisture from the separated hydrogen, etc. Here also, the balance of plant can be configured to collect the hydrogen delivered by the DOHPs in this was, and to perform any compression required prior to feeding the hydrogen to an hydrogen offtake interface from which the compressed hydrogen can be exported.

The hydrogen offtake interface may be connected to a subsea hydrogen pipeline connected for example to an onshore facility or to a larger backbone pipeline. Equally, a subsea hydrogen pipeline can connect two or more platforms of the electrolysis arrangement to form a network with a central export pipeline to shore, to a central offtake interface or to a connection point to a backbone pipeline.

An offtake interface can for example facilitate transfer of the export hydrogen to a hydrogen carrier vessel. Such an offtake interface can be provided at a main platform of the electrolysis arrangement, or at a suitably positioned mooring point (for example at an outer edge of the wind farm) at which a hydrogen carrier vessel can safely moor during a loading procedure.

In an embodiment, a plant controller is installed on the main platform. The plant controller can be configured to control the electrolysis arrangement (i.e., the various components of the balance of plant and the distributed electrolyzers). The plant controller may also be configured to control the wind turbines of the wind park. Each umbilical further encloses a data cable for exchanging data between the respective DOHP and the park controller. The park controller can monitor various aspects of the balance of plant and the distributed electrolyzers and can respond as appropriate. For example, the park controller of a PEM water electrolysis plant can monitor the level of buffered polished water stored locally at each DOHP. As the level of buffered polished water approaches a lower threshold, the park controller commands the water purifier system to send purified water to the respective DOHP.

The plant controller can also be configured to optimize the operation of the plant in various other exemplary situations. For example, the active DOHPs can inform the park controller of their current electrolyzer load and/or available electrical power, and the plant controller can distribute the available electrical power in a balanced manner among the DOHPs to balance the load level of the individual electrolyzers. In another example, multiple DOHPs may be in idle mode, and the plant controller can schedule an optimized sequential startup procedure based on the available power or system state of those DOHPs.

In low wind conditions, the plant controller can be configured to concentrate the available electrical energy on a subset of the electrolyzers, i.e., in some DOHPs the electrolyzers remain inactive and the wind turbines send electricity to the main platform for routing to the DOHPs with active electrolyzers. In this way, the number of electrolyzer startup procedures is kept to a minimum.

Equally, each DOHP of a PEM water electrolysis plant can send status information to the plant controller, for example to report on the quality of the purified water received at its polishing system, to report an excessively high level of hydrogen humidity, etc. On the basis of information received from one or more DOHPs, the plant controller can issue suitable commands. For example, commands can be issued to the water purification system to improve the water quality; commands can be issued to a relevant device to remove humidity from the hydrogen prior to export.

In a further exemplary scenario, the plant controller may respond to limited availability of the hydrogen offtake interface (owing to full buffer storage in case of transport by carrier vessel; excessive pipeline pressure; maintenance work; pipeline damage etc.) by commanding some or all of the DOHPs to shut down their respective electrolyzers.

The plant controller may also be equipped with a meteorological station configured to determine at least a short-term weather forecast and can control the DOHPs accordingly. For example, if wind speed is predicted to drop below the cut-in speed of a wind turbine but only for a short duration, the plant controller commands the respective DOHP to not shut down its electrolyzer and provides that DOHP with the required power until the wind turbine can resume operation. Equally, if wind speed is predicted to increase above the cut-in speed but only for a short duration, the plant controller commands the respective DOHP to not initiate startup of its electrolyzer.

An umbilical further encloses a power cable for exchanging electrical energy between the respective DOHP and an electrical installation on the main platform, for example an energy storage device, a small energy buffer, an electrical interface directly connecting the individual DOHPs, etc. In this way, the electrolyzer of the respective DOHP can be powered using electrical energy generated by other wind turbines of the wind park, for example if the wind turbine of that DOHP is unable to generate electricity, but the wind park as a whole is generating sufficient power to cover the deficit.

In an embodiment of the invention, the balance of plant further comprises a backup power supply configured to provide backup power to auxiliaries of the wind turbines. Such backup power may be required during times of low wind, for example. The backup power supply can comprise any of a fuel cell, a battery, a gas motor, a heat engine, a redox flow battery, a supercapacitor, a flywheel, etc.

In an embodiment of the invention, the electrolyzer of a downstream wind turbine can be operated using electrical energy generated by upstream wind turbines. In such an embodiment, the wind park controller issues commands and references as appropriate to direct electrical energy from one or more upstream wind turbines (i.e., wind turbines most exposed to the incoming wind) to the electrolyzers of downstream turbines. In this way, essentially the same load level can be achieved for all electrolyzers of the distributed electrolysis plant.

In low wind situations or for other reasons, some or all of the wind turbines may be shut down. Each wind turbine could be equipped with its own backup power supply. In an alternative approach, the wind park can deploy a large-capacity backup power supply that is capable of restarting multiple wind turbines. In each case, the costs of providing and maintaining the backup power supply (e.g., a diesel generator, a battery, etc.) are high. In the inventive wind-powered electrolysis arrangement, re-starting wind turbines is done in a more efficient manner, avoiding the need to provide one or more large backup power supplies for the entire wind farm or many backup power supplies for the individual wind turbines. Instead, the inventive method comprises a step of initiating startup of a first wind turbine using electricity generated by other wind turbines of the wind park.

### BRIEF DESCRIPTION

Some of the embodiments will be described in detail, with reference to the following figures, wherein like designations denote like members, wherein:

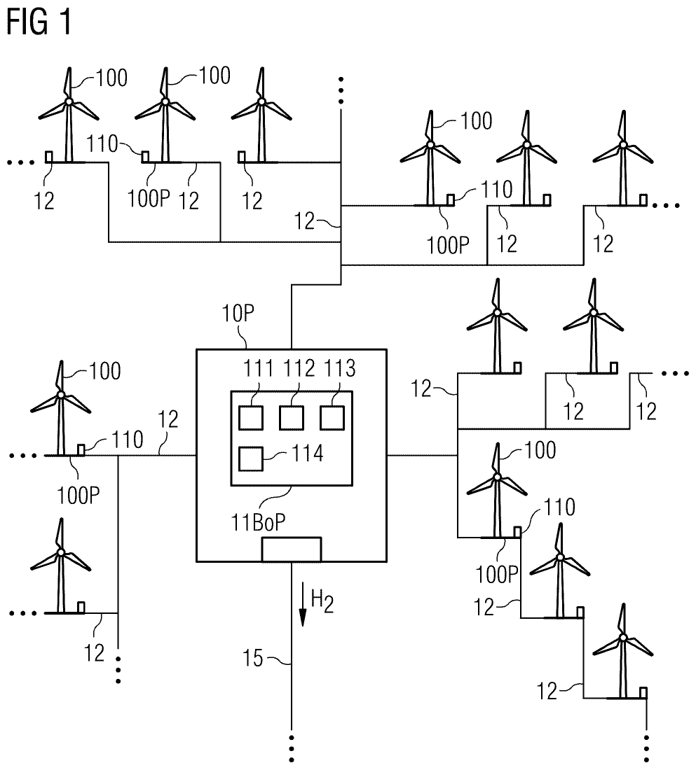

FIG. 1 shows an embodiment of the inventive wind-powered electrolysis arrangement;

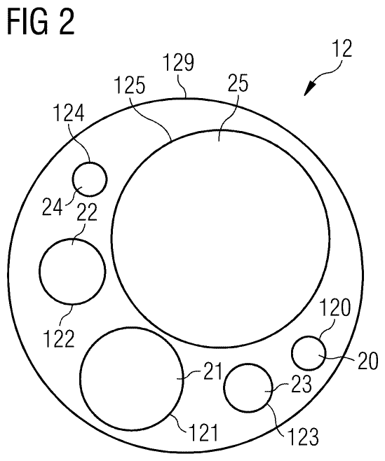

FIG. 2 is a simplified cross-section through an umbilical pipe in a first embodiment of the inventive wind-powered electrolysis arrangement;

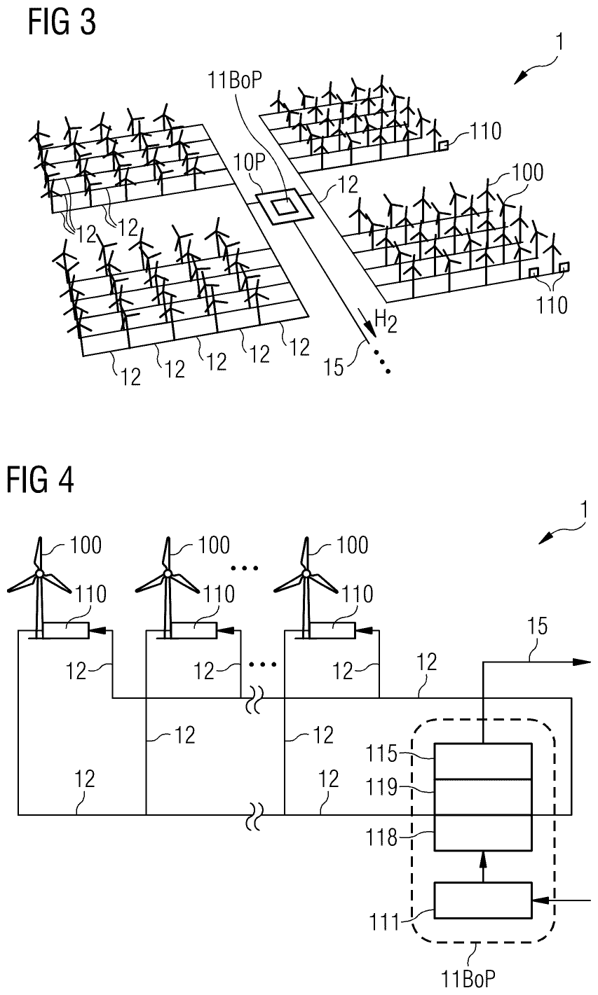

FIG. 3 shows a schematic perspective view of an embodiment of the inventive wind-powered electrolysis arrangement;

FIG. 4 is a simplified representation view of a further embodiment of the inventive wind-powered electrolysis arrangement;

FIG. 5 is a simplified cross-section through an umbilical pipe for the wind-powered electrolysis arrangement of FIG. 4;

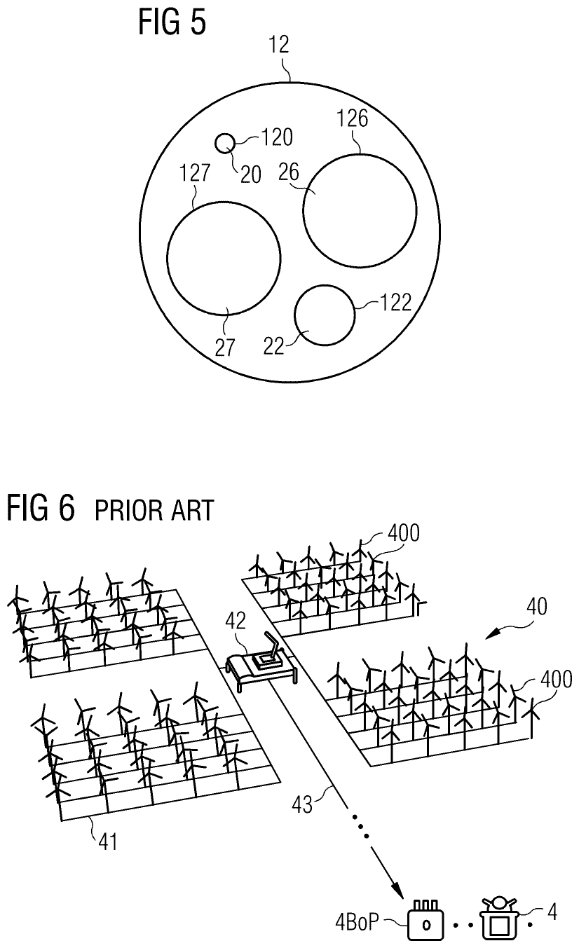

FIG. 6 shows a conventional wind-powered electrolysis arrangement;

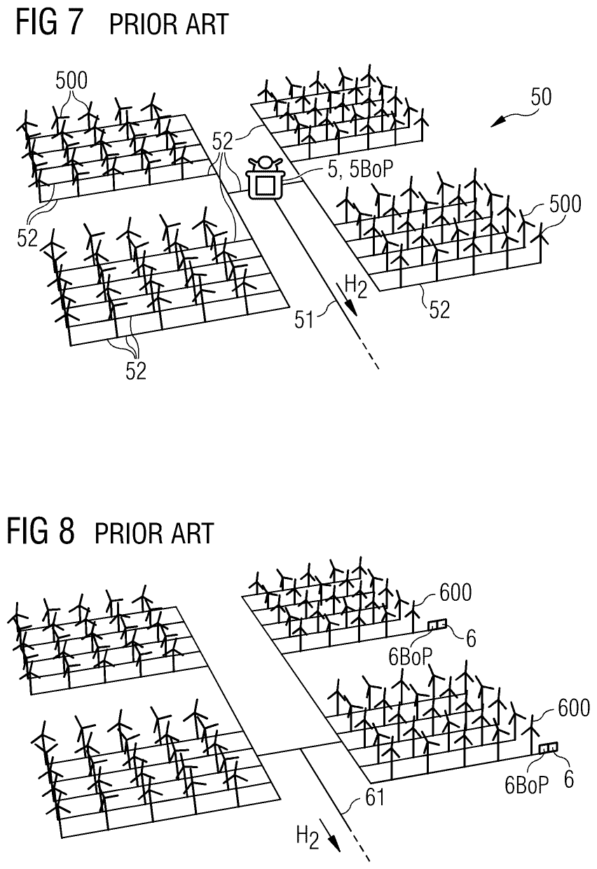

FIG. 7 shows a conventional wind-powered electrolysis arrangement; and

FIG. 8 shows a conventional wind-powered electrolysis arrangement.

### DETAILED DESCRIPTION

FIG. 1 shows an embodiment of the inventive wind-powered electrolysis arrangement 1, in which the wind turbines 100 of an offshore wind park 10 generate electricity to drive PEM water electrolyzers 110 of a distributed large-scale electrolyzer plant 11. The balance of plant 11BoP for the electrolyzer plant 11 is installed on a main platform 10P which can be provided centrally or at any convenient location in the wind farm 10WP. Of course, depending on factors such as the size of the wind farm and the number of electrolyzers in the distributed electrolyzer plant, one or more additional main platforms can be provided at suitable locations. Any main platform can be fully automated, intermittently manned or permanently manned.

In this exemplary embodiment, a single main platform is shown. The balance of plant 11BoP comprises a water purifier system 111, a backup power supply 112, a nitrogen supply 113, an instrument air supply 114, a hydrogen offtake interface 115. A plurality of umbilical pipelines 12 is provided, each connecting a wind turbine 10 to the main platform 104. Each umbilical 12 comprises an outer pipe 129 enclosing multiple inner pipes, cables, etc.

FIG. 2 is a simplified cross-section through an exemplary umbilical 12 for the plant of FIG. 1, showing the arrangement of inner pipes 121, 123, 124, 125 and cables 120, 122 in its interior. Here, the outer pipe 129 of the umbilical 12 encloses a hydrogen pipe 125, a nitrogen pipe 123, an instrument air pipe 124, a purified water pipe 121, a data cable 120, and an electricity cable 122. The outer pipe 129 of an umbilical 12 can be made of HDPE, for example and can be laid on the seabed. The outer pipe 129 can be armored, as will be known to the skilled person, to protect against damage. Equally, the outer pipe 129 can be weighted so that the umbilical 12 will rest on the seabed. Depending on the fluid that it will convey, an inner pipe 121, 123, 124, 125 can be made of a metal (stainless steel, a chrome-based alloy, a nickel-based alloy, titanium, aluminium etc.), a synthetic material such as polyethylene (for example HDPE), a composite material, etc. The space between the inner pipes and cables can be filled with a suitable material such as a thermoplastic, a foam, etc.

Any such umbilical 12 can be pre-assembled in a factory by arranging suitable lengths of the required inner pipes and cables in the interior of a suitably long outer pipe 129, so that the completed umbilical 12 can be installed between two points of the inventive wind-powered electrolysis arrangement 1 in a single favorably straightforward operation that is significantly less complex than having to insert inner pipes and cables into a previously installed outer pipe. In the exemplary embodiment shown in FIG. 1, a single water purifier system 111 can supply purified water 21 to each of the electrolyzers 110; a single backup power supply 112 can provide electrical energy 22 to each of the electrolyzers 110; a single nitrogen supply 113 can supply nitrogen 23 to each of the electrolyzers 110; a single instrument air supply 114 can supply compressed air 24 to each of the electrolyzers 110.

The hydrogen 25 generated at each electrolyzer 110 is transported to the main platform 10P, where the hydrogen offtake interface 115 compresses the hydrogen for export by pipeline 15 to an onshore landfall facility, to a larger “backbone” export pipeline, to a fueling facility for transfer to a hydrogen carrier, etc.

Maintenance and repair procedures to the balance of plant 11BoP is straightforward, since the single water purifier system 111, single backup power supply 112, single nitrogen supply 113, single instrument air supply 114 and single hydrogen offtake interface 115 are all located on the easily accessible main platform 10P. This can be constructed to facilitate mooring of one or more supply vessels, for example. Equally, the main platform 10P can have a helicopter landing zone. Even in a configuration that uses more than one main platform, maintenance and repair procedures to the balance of plant 11 BoP are still favorably straightforward, since the number of components requiring service is still very low. FIG. 3 shows a schematic perspective view of the inventive wind-powered electrolysis arrangement 1, showing the wind turbines 100 of the wind park 10 and a centrally placed main platform 10P and the installed balance of plant 11BoP described above. The diagram also indicates an exemplary arrangement of umbilical pipes 12 connecting the distributed electrolyzers 110 with the balance of plant 11BoP on the main platform 10P.

FIG. 4 shows a further embodiment of the inventive wind-powered electrolysis arrangement 1. Here, each DOHP of the distributed electrolysis plant comprises alkaline electrolyzers 110. In addition to a water purifier 111 (which may use ground water, sea water etc. and which may comprise any number of sub-systems necessary for providing purified water at its outlet), the balance of plant 11BoP is equipped with a electrolyte mixer 118 which mixes a suitable quantity of an electrolyte with the purified water. The aqueous alkaline mixture is then piped to each electrolyzer 110, and a hydrogen-enriched alkaline mixture is returned by pipeline to the balance of plant 11BoP. FIG. 5 is a simplified cross-section through an umbilical 12, showing a basic configuration of four pipes, in this case an outgoing electrolyte pipe 126 (conveying a fluid 26 comprising purified water and an alkali), a return electrolyte pipe 127 (conveying a fluid 27 comprising the alkaline mixture as well as dissolved hydrogen gas); and a data cable 120 and an electricity cable 122 for the wind turbine of each DOHP. At the balance of plant 11BoP, a separator 119 then removes the dissolved hydrogen gas from the returned electrolyte 27. FIGS. 6-8 show various wind-powered electrolysis arrangements known from the conventional art, each making use of an offshore wind-park 11 to generate electricity required for water electrolysis.

FIG. 6 illustrates a “shoreline solution” in which a large-scale electrolyzer 4 and its balance of plant 4BoP are located onshore. In this approach, the wind turbines 400 of a wind farm 40 generate electricity which is transported via power cables 41 to a substation 42 located on a platform, and then exported to shore in the conventional manner, for example by an export power line 43 as indicated. However, the unavoidable losses associated with transport of electrical power from the wind turbines 400 to the substation 42 and from the substation 42 to shore, particularly if the wind farm is a long distance from the onshore electrolyzer, means that this configuration can be very inefficient.

FIG. 7 shows a “central solution” in which a large-scale electrolyzer 5 and its balance of plant 5BoP are located offshore and in physical proximity to a wind park 50, for example on a central platform within the wind park 50, and hydrogen is brought to shore via pipeline 51. In such a configuration, each wind turbine 500 generates electricity which is transported via power cables 52 to a substation at the central platform. The drawback of this type of configuration is that, even though the power is transported over a shorter distance than in FIG. 4 above, the cable losses and transformer losses remain significant. Furthermore, placement of a water electrolyzer and its balance of plant in close proximity to an electrical transformer may only be possible if strict safety requirements are fulfilled, so that the costs of constructing such a platform can be significant. The safety requirements ensure that the explosive oxygen, i.e., the waste product of water electrolysis, is kept apart from any electrical component that might overheat or generate sparks. An alternative would be to install the water electrolyzer and its balance of plant on one central platform, and to provide the transformer and park controller on a separate platform, but such a configuration may ultimately be equally expensive.

FIG. 8 shows an alternative “decentralized solution” in which each wind turbine 600 of a wind park 60 could be equipped with a small-scale electrolyzer 6 along with its own suitably scaled balance of plant 6BoP. In this approach, each wind turbine 600 drives a local electrolyzer 6 directly, so that cable losses are not an issue. However, each electrolyzer 6 requires at least its own water purifier system, backup power supply, nitrogen supply, instrument air supply, hydrogen compressor and offtake interface, etc. A hydrogen export pipeline must be provided for each wind turbine installation, so that hydrogen from the electrolyzers 6 can be conveyed to an export pipeline 61 for transport to a landfall facility.

The inventive approach, as described in FIGS. 1-3 above, presents a favorable configuration that exploits the benefits of the other three types of configurations explained in FIGS. 4-6 while avoiding their drawbacks, thus providing an economical and efficient way of using wind power to drive water electrolysis.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A wind-powered electrolysis arrangement comprising:
a plurality of wind turbines of an offshore wind park; and
a distributed electrolyzer plant comprising a plurality of electrolyzers, wherein each electrolyzer is arranged on a wind turbine platform;
a balance of plant of the distributed electrolyzer plant, installed on a main platform in the offshore wind park; and
a plurality of product pipelines, wherein each product pipeline is arranged to convey a number of products between the balance of plant and a distributed electrolyzer.

2. The wind-powered electrolysis arrangement according to claim 1, wherein the balance of plant comprises at least a water purifier system for generating a supply of purified water for the distributed electrolyzer plant, and a hydrogen offtake interface for collecting hydrogen from the distributed electrolyzer plant.

3. The wind-powered electrolysis arrangement according to claim 1, comprising:
a number of product pipelines, each extending between two wind turbine platforms; and
a number of product pipelines, each extending from the wind turbine platform to the main platform.

4. The wind-powered electrolysis arrangement according to claim 3, wherein the electrolyzers of the distributed electrolyzer plant are configured to perform proton exchange membrane electrolysis, and wherein a product pipeline encloses:
a purified water pipe arranged to convey purified water from the balance of plant to the distributed electrolyzer; and
a hydrogen pipe arranged to convey hydrogen from the distributed electrolyzer to the balance of plant.

5. The wind-powered electrolysis arrangement according to claim 4, wherein the balance of plant further comprises a nitrogen supply and/or an instrument air supply.

6. The wind-powered electrolysis arrangement according to claim 1, wherein a wind turbine of the plurality of wind turbines is equipped with a water polishing unit.

7. The wind-powered electrolysis arrangement according to claim 1, wherein the electrolyzers of the distributed electrolyzer plant are configured to perform alkaline water electrolysis, and wherein a product pipeline encloses:
an outgoing electrolyte pipe arranged to convey an outgoing electrolyte from the balance of plant to the distributed electrolyzer; and
a return electrolyte pipe arranged to convey a return electrolyte from the distributed electrolyzer to the balance of plant.

8. The wind-powered electrolysis arrangement according to claim 7, wherein the balance of plant further comprises a separator for removing gaseous hydrogen from the return electrolyte.

9. The wind-powered electrolysis arrangement according to claim 1, wherein the balance of plant is installed on a main platform located centrally in the offshore wind park.

10. The wind-powered electrolysis arrangement according to claim 1, comprising a hydrogen export pipeline extending from the main platform to a further facility.

11. A method of operating a wind-powered electrolysis arrangement according to claim 1, which method comprises:
operating the balance of plant to generate products required by the electrolyzers of the distributed electrolyzer plant;
conveying the required products through the product pipelines to the electrolyzers;
operating an electrolyzers using electrical power generated by a respective wind turbine; and
conveying hydrogen from the electrolyzers through the product pipelines to the main platform.

12. The method according to claim 11, comprising:
collecting hydrogen produced by proton-exchange-membrane (PEM) electrolysis; or
separating gaseous hydrogen from the return electrolyte produced by alkaline water electrolysis at the main platform for export to a further facility.

13. The method according to claim 11, comprising operating the electrolyzer of a wind turbine using electrical energy generated by one or more other wind turbines.

14. The method according to claim 13, comprising operating the electrolyzer of a downstream wind turbine using electrical energy generated by one or more upstream wind turbines.

15. The method according to claim 11, comprising operating a water purifier system of the balance of plant to provide purified water to each electrolyzer of a PEM electrolysis plant; or to provide purified water to the electrolyte mixing unit of an alkaline water electrolysis plant.
